(19) United States
(12) Patent Application Publication
(10) Pub. No.: US 2026/0060405 A1
(43) Pub. Date: Mar. 5, 2026

(54) STAND AND TOOLS

(71) Applicant: UDU Beauty, Inc., Wilmington, DE (US)

(72) Inventors: Michelle OBEN, Brooklyn, NY (US); Michael BAMBINO, Brooklyn, NY (US); Adrian CANDELA, Denver, CO (US)

(21) Appl. No.: 19/315,184

(22) Filed: Aug. 29, 2025

Related U.S. Application Data
(60) Provisional application No. 63/689,833, filed on Sep. 2, 2024.

(51) Int. Cl. A45D 44/04; A46B 5/02; A46B 17/08

(52) U.S. Cl. CPC A45D 44/04; A46B 5/021; A46B 17/08; A46B 2200/1046

(57) ABSTRACT

A base and tool set including a base having at least a first designated area and a second designated area, each of the designated areas comprising one of a magnet and a metal element, a first tool corresponding to the first designated area having the other of the magnet and metal element at a bottom of the first tool, and a second tool corresponding to the second designated area having the other of the magnet and metal element at a bottom of the second tool, wherein the first and second tools stand on the base respectively on the first and second designated areas in an upright orientation.

### FIELD OF THE INVENTION

The present invention relates to the field of stands and tools, including a stand comprising a base that enables storage and accessibility of tools and tools and facilitates ease of use for users, especially those with disabilities or mobility impairments.

### BACKGROUND OF THE INVENTION

Most generally, tools requiring manual manipulation for use are well known, as are issues related to the storage, accessibility and manipulation of those tools. These issues become more important when the user has limited physical dexterity, both slight and more advanced, due to things like aging, osteoarthritis, limb difference, disease, mobility impairments and/or disabilities (hereinafter referred to as “impairments”).

These mobility impairments leave many people abandoning parts of their routine, or asking for help from a partner or friend—things that make them feel like they are sacrificing a sense of self. For example, applying make-up is often a time consuming and multi-step process, generally involving dedicated application tools. These may include things like mascara containers with applicators, eyeliner brushes, eyeshadow brushes, powder brushes and the like, all of which will be referred to herein as “tools.”

The proper use of tools, such as for the application of make-up, requires that the user have good control of the make-up tools being used. However, many make-up tools have either short, stubby handles that can only be engaged by a limited number of fingers or long, thin handles that can slip through one's fingers. This is sometimes a challenge for users with good dexterity, and is often a greater challenge for users with limited dexterity due to aging, a disability, or similar physical impairment issues.

Additionally, storage of make-up tools can be difficult, where the tools often contain trace amounts of make-up that can dirty countertops, trays, cosmetic bags and other storage containers. These storage methods also create additional challenges for users with impairments that result in limited dexterity, where it may be difficult to grasp the tools from where they are stored prior to use and to put away tools for storage after use is completed.

Similar issues are encountered with tools used for other tasks, including but not limited to haircare, which may require one or more brushes, combs, curlers, and/or other haircare tools, skincare, which may include jade rollers, wands and exfoliators, personal care, which may include tweezers, nail clippers and razors, home repair, which may require screwdrivers, pliers, and/or other mechanical tools, cooking, which may require spatulas, ladles, tongs, and/or other utensils or gadgets, etc. These uses require the storage, accessibility and manipulation of tools that can be difficult for all users, especially users with impairments.

What is therefore needed is a stand for convenient storage of tools, the stand having features for aiding in the storage and access to the tools, and tools comprising features for improving the ease of grasping and holding the tools during use.

### SUMMARY OF THE INVENTION

The present invention is directed to a stand and tools having features for ease of storage, accessibility and use, including use by those with physical impairments.

The stand of the present invention preferably comprises a substantially flat base having two or more designated areas for holding tools, preferably in an up-right manner so that a user can easily pick up the tool, as opposed to picking them up as they lay flat on a counter or within a bag. The preferred tools have bottom ends, generally opposite the working ends of the tools, that cooperate with the designated areas of the base, including cooperating elements to help maintain the tools on the base in a user accessible, upright orientation.

With respect to the invention, the base may be flat, with or without markings for tool placement, or may include designated areas with ridges and/or indentations that correspond to the size and shape of the bottoms of the tools to ensure proper placement of the tools on the base.

Preferably, the base and one or more of the tools include cooperating magnetic features corresponding to the bottom of the tool or tools and one or more of the designated area or areas of the base. For example, one of the tools and the base may have a magnet incorporated therein and the other of the tools and the base may have a metal that responds to the attractive force of the magnet, being a magnetic element such as a magnetic metal plate. It is preferred that the base have sufficient weight to reduce or eliminate movement of the stand when the magnetic force holding the tool to the base is overcome during removal of the tool from the base or replacement of the tool on the base.

In a preferred embodiment, the bottoms of the tools and the designated areas of the base are substantially flat with a magnet at the bottom of the tool that attracts a magnetic element on the base in a particular area on the base, unmarked, designated with a marking or having a ridge and/or indentation that corresponds to the size and shape of the bottom of the tool. The magnet at the bottom of each tool is used to set and hold the tool into place on the base.

The base can also be modular, preferably with ends and one or more intermediate portions corresponding to one or more tools. For example, the base may comprise two independent ends, each with or without designated areas for holding a tool, and optionally one or more intermediate portions with designated areas for one or more tools that can be inserted between the independent ends. In one embodiment, an intermediate portion will accompany a new tool where the intermediate portion will have a designated area corresponding to the bottom of the new tool.

In an embodiment, the base may have additional functionality, including features such as conductive charging to allow charging of electric tools when place on the base. For example, conductive charging can be used when an electric toothbrush or an electric curling iron is featured as a tool on the base.

In one embodiment, the ends and the intermediate portions have attachment members to hold the ends and intermediate portions together as a base unit, including cooperating magnets, latches, catches, clips, etc. The attachment members can create a permanent attachment between the components, i.e., with snap-in barbed arms, adhesives or the like, so that the ends and optional intermediate portions form a fixed component stand when permanently attached. Alternatively, the attachment features can create a releasable attachment for adding/removing intermediate portions when desired.

The preferred tools of the present invention comprise a working feature, a handle and a terminal bottom end. In one embodiment, the tool can have multiple components, for example, a mascara applicator comprising a mascara container for holding the mascara making up the bottom end and a removable applicator with a working feature for applying the mascara. Similar tools may include an adhesive container with a brush for applying an adhesive, a cosmetic container with an applicator brush, etc.

One or more, and preferably all of the tools, have features that improve their ability to be grasped and held for manipulation of the working feature by the user. For example, some preferred tools have enlarged handles, and containers when part of the tool, so the user doesn't need to form a tight grip. Others have split handles, with two or more handle portions and an open middle, allowing for multiple ways to hold them, including around all or some of the handle portions, by only one of the portions of the handle portions by passing or weaving fingers through or around the handle portions and opening, depending on what gives the user the greatest stability. In one embodiment, the handle will have a soft texture that is not slippery, to improve retention of the tool.

In several embodiments, one or all of the handle portions can be rigid, semi-rigid or flexible, as well as combinations thereof. Preferably, the handle will be at least partially flexible while returning to its original shape, like a whisk, to accommodate for the user's grip strength. Also preferred is a handle that does not have a cylindrical configuration, to ensure that the tool does not roll off of a surface on which it is placed.

Depending on the tool and how the tool is expected to be held, the handle may have an enlarged opening between handle portions in different positions, i.e., nearer the working feature, in the middle between the working feature and the bottom of the tool, or nearer the bottom of the tool. For example, the tools may comprise make-up brushes, where an eyeliner brush may have a wide space closest to the brush, as it likely requires the user to rest their hand against their face as they use the brush, and an eyeshadow brush may have a wide space towards the base, as there is less control needed.

It is understood that the base and tools can be part of a set, but are also separate, independent items, that do not need to comprise a specific base and specific tools. In this regard, the features of the tools themselves may be independently protectable as aiding use of a tool, without regard to the stand.

### BRIEF DESCRIPTION OF THE DRAWINGS

The present invention will be better understood when considered in view of the attached drawings, in which like reference characters indicate like parts. The drawings, however, are presented merely to illustrate the preferred embodiments of the invention without limiting the invention in any manner whatsoever.

FIG. 1A is a perspective view of a base and tools in the form of a set according to the present invention.

FIG. 1B is a front elevation of the base and tool set of FIG. 1A.

FIG. 1C is a top plan view of a the base and tool set of FIG. 1A.

FIG. 2A is a perspective view of a base according to the present invention.

FIG. 2B is a top plan view of the base of FIG. 2A.

FIG. 2C is a bottom plan view of the base of FIG. 2A.

FIG. 2D is a front elevation of the base of FIG. 2A.

FIG. 2E is a side elevation of the base of FIG. 2A.

FIG. 3A is a perspective view of a mascara tool according to the present invention.

FIG. 3B is an exploded front elevation of the mascara tool of FIG. 3A.

FIG. 3C is a front elevation of the mascara tool of FIG. 3A.

FIG. 3D is a side elevation of the mascara tool of FIG. 3A.

FIG. 3E is a top plan view of the mascara tool of FIG. 3A.

FIG. 3F is a bottom plan view of the mascara tool of FIG. 3A.

FIG. 4A is a perspective view of an eyeliner brush according to the present invention.

FIG. 4B is a side elevation of the eyeliner brush of FIG. 4A.

FIG. 4C is a rear elevation of the eyeliner brush of FIG. 4A.

FIG. 4D is a top plan view of the eyeliner brush of FIG. 4A.

FIG. 4E is a bottom plan view of the eyeliner brush of FIG. 4A.

FIG. 5A is a perspective view of an eyeshadow brush according to the present invention.

FIG. 5B is a side elevation of the eyeshadow brush of FIG. 5A.

FIG. 5C is a front elevation of the eyeshadow brush of FIG. 5A.

FIG. 5D is a top plan view of the eyeshadow brush of FIG. 5A.

FIG. 5E is a bottom plan view of the eyeshadow brush of FIG. 5A.

FIG. 6A is a partial transparency showing the insertion of a store-bought mascara into the mascara container of FIG. 3A.

FIG. 6B is a partial transparency showing the securing of the store-bought mascara in the mascara container of FIG. 3A.

FIG. 6C is an exploded view of the mascara tool with a store-bought mascara in the mascara container of FIG. 3A.

FIG. 7 is a perspective view of a base and tools in the form of a set according to the present invention.

FIG. 8 is a front elevation of the base and tool set of FIG. 7.

FIG. 9 is a is a perspective view of a base according to the present invention.

### DETAILED DESCRIPTION OF THE PREFERRED EMBODIMENTS

The following description of the preferred embodiments is presented to describe the present invention without limiting the scope of the invention.

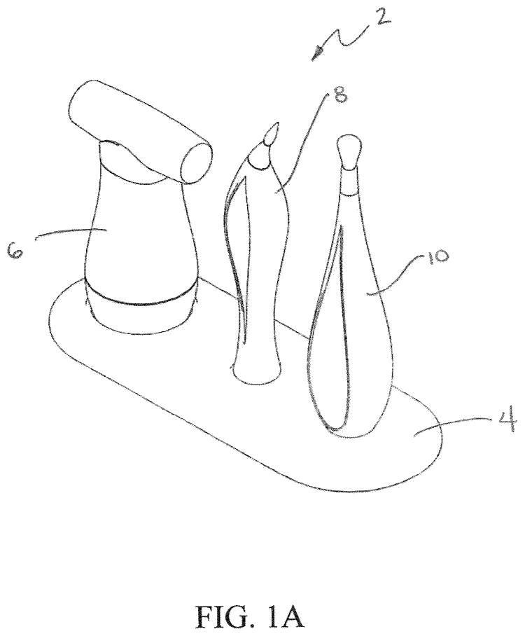

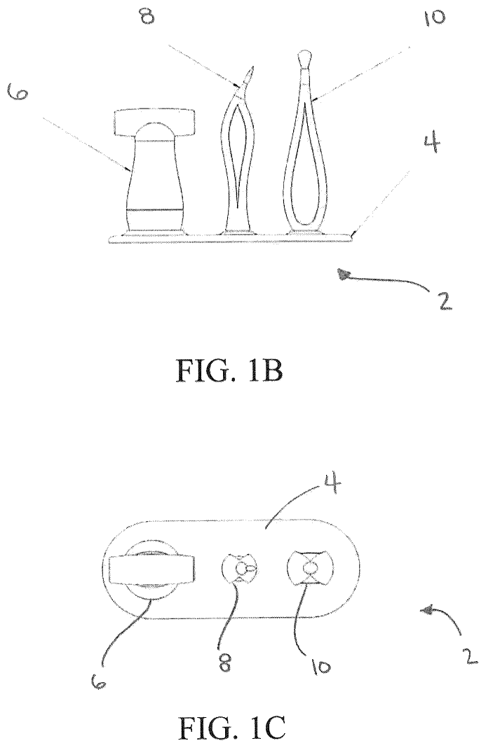

A preferred embodiment of the present invention shown in the accompanying drawings, and particularly FIGS. 1A, 1B and 1C, is shown as a make-up set 2, comprising a base 4 and a variety of tools, preferably including one or more cosmetics brushes. For example, the embodiment illustrated in FIGS. 1A, 1B and 1C includes, without limitation, a mascara tool 6, an eyeliner brush 8 and an eyeshadow brush 10.

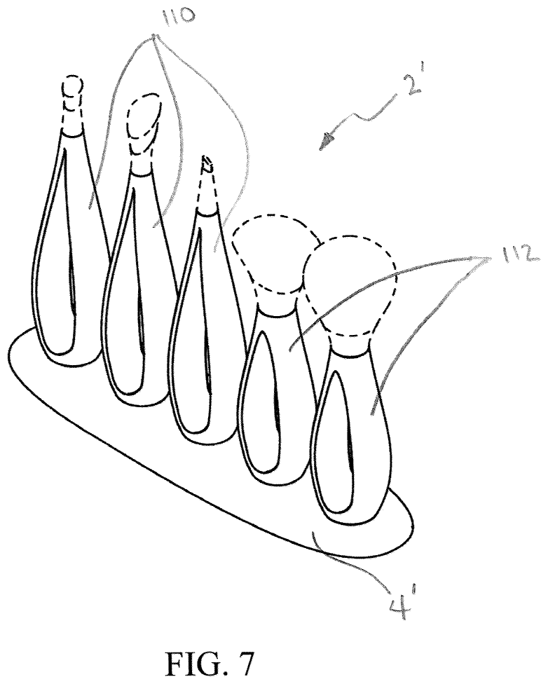

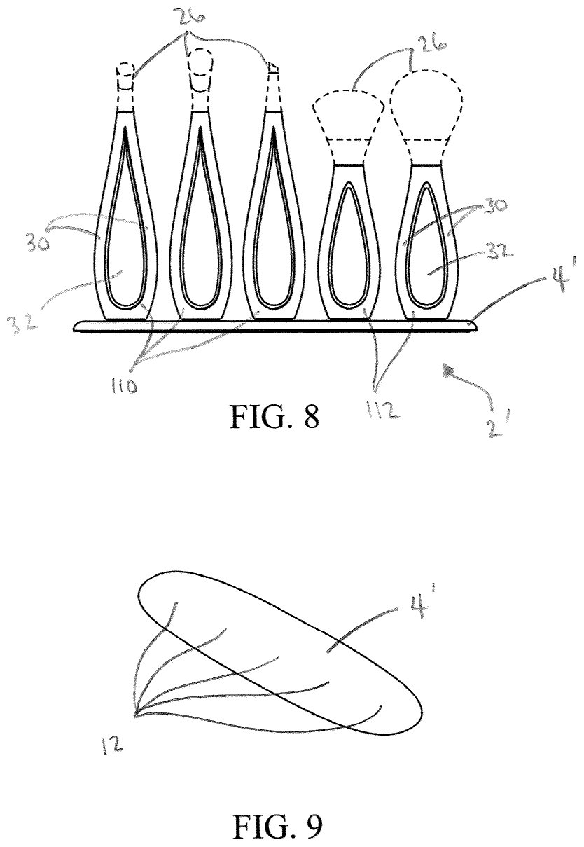

Another embodiment, which is shown in FIGS. 7, 8 and 9, comprises one or more of each of a series of brushes, including a base 4, one or more long handled brushes 110 and one or more short handled brushes 112.

The base 4 is designed as a stand to hold tools in an upright orientation, permitting a user to easily pick up the tool, as opposed to picking up the tool as it lays flat on a counter, on a tray or within a bag.

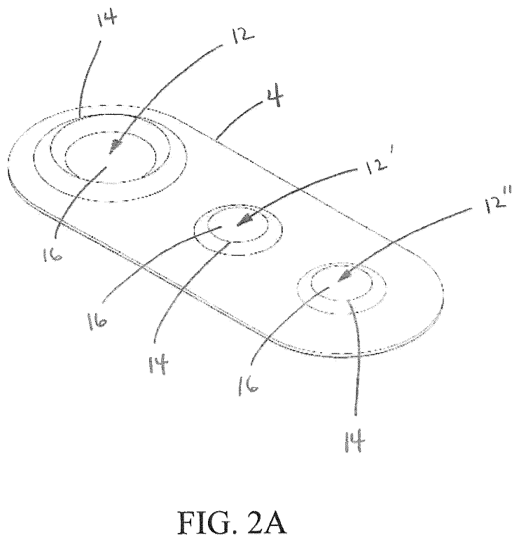

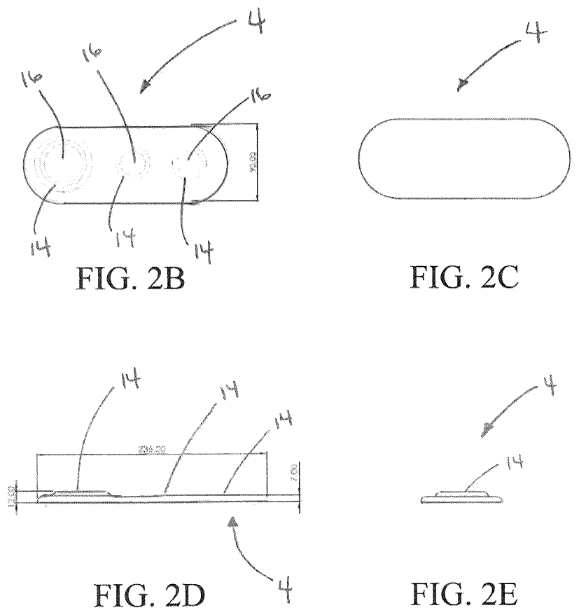

The base 4, more particularly shown in FIGS. 2A to 2E, comprises a plurality of designated areas 12 on which the tools 6, 8 and 10 are placed. These designated areas 12 may have physical designations on the surface of the base 4, which are visual indicators for placement of the tools. Alternatively, as shown in FIGS. 7, 8 and 9, the base 4′ can be formed without visible designated areas 12, where the designated areas 12 are defined by one or more magnets/magnetic elements positioned within the base that correspond to cooperating magnets/magnetic elements associated with the terminal ends of the tools.

It is also understood that the base can have fewer or more than three designated areas 12 shown in FIGS. 1A-2E, based on the desired number of tools to be held.

In the embodiment of FIGS. 1A-2E, the designated areas 12 are defined by a ridge 14 creating a depression 16 in the size and shape of the bottom of the tool to be held in place. The designated areas 12 also preferably comprise one of a magnet (such as a neodymium magnet) or metal element attracted by the magnet (such as a steel disc or plate), not shown, where the bottom of the corresponding tool has the other of a magnet or metal element to provide a cooperating magnetic attachment between the base 4 and the tools in the designated areas 12. Accordingly, the designated areas 12 assist in securely holding the specific tools in particular designated areas 12, here snapping each tool into the depression 16 surrounded by the ridge 14 by magnetic attraction.

In an alternative embodiment shown in FIGS. 7-9, the base 4′ is flat without any physical elements or visible indicators for defining placement of the tools. Notwithstanding, the base 4′ has designated areas 12 for placement of a plurality of tools, preferably comprising one of a magnet or metal element attracted by the magnet, where the bottom of the corresponding tool has the other of a magnet or metal element to provide a cooperating magnetic attachment between the base 4′ and the tools in the designated areas 12, as described above. Similar to the base 4 with physical, the designated areas 12 assist in securely holding the specific tools in particular designated areas 12

It is also preferred that the weight of the base 4 be sufficiently heavy to generally allow the base 4 to stay in place on a counter as the user lifts a tool off of the base 4, and as the user returns the tool to the base 4.

In a preferred embodiment, the base 4 has a weighted plastic core, with magnetic metal elements, including ferromagnetic metals such as A36 or A500 low carbon steel, in at least in the designated areas 12, and an elastomeric coating that may be injection molded over the core. For example, the plastic can be a polypropylene or polyethylene, with a zinc or ferromagnetic metal core, A36 or A500 low carbon steel elements in the designated areas, all covered by a thermoplastic polyurethane (TPU) outer layer.

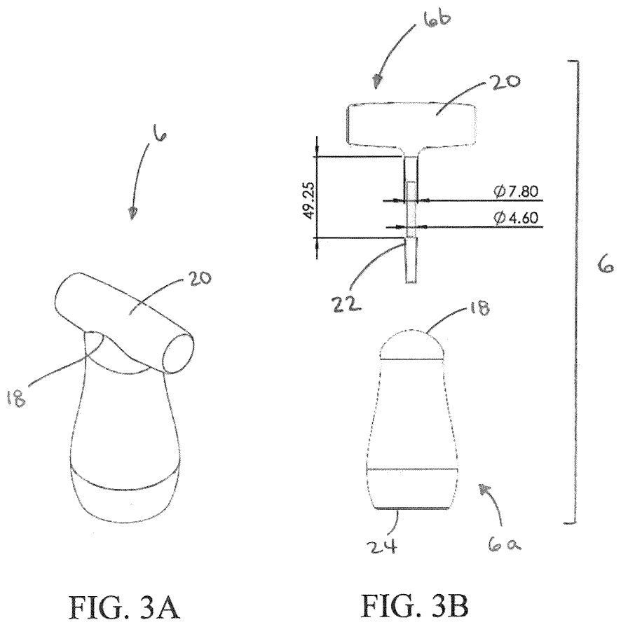

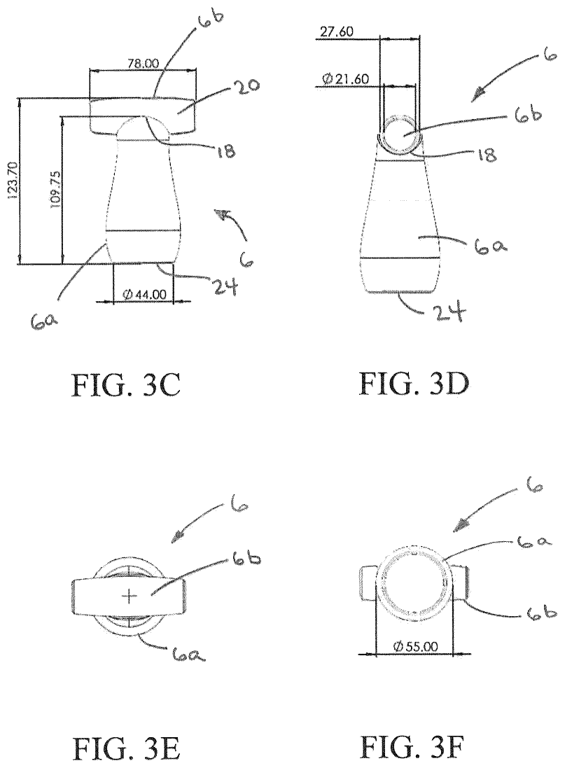

A potential tool in the form of a mascara tool 6 is shown in FIGS. 3A to 3F. As shown in FIG. 3B, the mascara tool 6 may comprise a container 6a and an applicator 6b, where the container 6a is configured to hold a store-bought mascara tube for use with the preferred applicator 6b of the present invention. In the preferred embodiment, the container 6a has a magnet 24 at the bottom that is sufficiently attracted to the magnetic designated area 12 to hold the container 6a in place when the applicator 6b is inserted and removed for use.

The applicator 6a is preferably formed in a T-shape, with an enlarged handle portion 20 and a brush portion 22 extending perpendicularly from the middle of the handle portion 20. It is preferred that the container 6a have a saddle shaped top edge 18 in which the enlarged handle portion 20 of the T-shaped applicator 6b rests.

The enlarged body of container 6a and the enlarged handle portion 20 of the applicator 6b can be more easily gripped by the user, due to the enlarged size. The applicator 6b can be lifted straight up from the container 6a for removal, while rotating the applicator 6b about the axis of the brush portion 22 may assist to elevate the applicator 6b along the sides of the saddle shaped top edge 18 of the container 6a.

This configuration overcomes common problems with store-bought mascaras, including twisting a wand off of a tube, which generally takes two hands and becomes harder over use as mascara builds up between the tube and wand, and repeated dipping of the wand into to the tube, which also generally requires two hands.

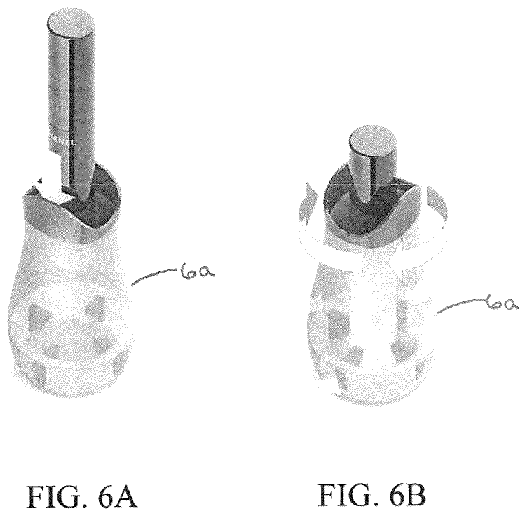

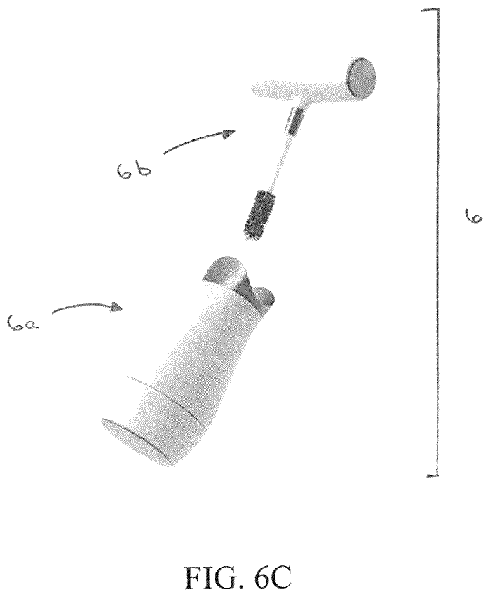

The preferred container 6a of the mascara tool 6 is designed to hold the tube of a store-bought mascara. A most preferred embodiment comprises a vertical opening in the container 6a, into which a store-bought mascara tube can be inserted in an upright orientation to prevent the user from having to pick it up, with a twist-to-lock/unlock feature in the container 6a that releasably secures the tube in the opening, while using the applicator 6b of the present invention (as shown in FIGS. 6A-6C). Once the tube is inserted into the container 6a, as shown in FIG. 6A, and secured in the container 6a, as shown in FIG. 6B, the user can dispose of the wand from the store-bought mascara and use the applicator 6b with the store-bought mascara tube that has been secured in the container 6a, as shown in FIG. 6C.

The container 6a is intended to provide an air-tight closure with the applicator 6b to prevent the mascara in the container 6a from drying up, which may be facilitated by corresponding magnetic, stopper, twist, snap or other elements known in the art to improve an air-tight closure. In a preferred embodiment, container 6a comprises a main body including a twist base, an internal gasket and internal grip features (not shown) for securing the tube in the container 6a. It is contemplated that the container be made of plastic, preferably a polypropylene or polyethylene, with a metal insert, preferably being aluminum or stainless steel, and an elastomeric covering, preferably being a thermoplastic polyurethane (TPU) for improved grip.

The handle portion 20 of the applicator extends perpendicular to the brush portion 22, allowing the user to hold the handle with multiple fingers. It is preferred that the middle of the handle portion 20 is wider than the ends, and that the exterior of the handle portion 20 have a soft texture which is not slippery for a better grip. The brush portion 22 may be permanently attached to the handle portion 20 of the applicator 6b or the applicator 6b may have replaceable brush portions 22, with replacement applicators 6b or brush portions 22 offered to provide variations in length, width shape and thickness of the brush portion 22.

The handle portion 20 of the applicator 6b preferably includes flat ends, which can be fashioned as logo end caps. It can be made from any suitable materials, but may be made of plastic, preferably a polypropylene or polyethylene, with a metal core, preferably an aluminum or stainless steel, and an elastomer coating, preferably a thermoplastic polyurethane (TPU) for improved grip.

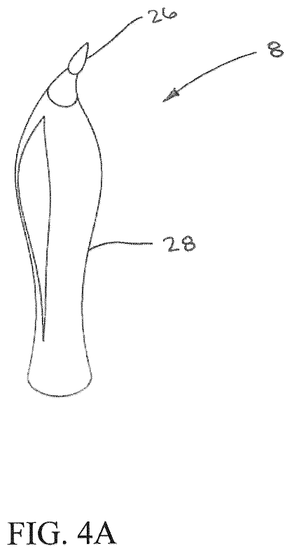

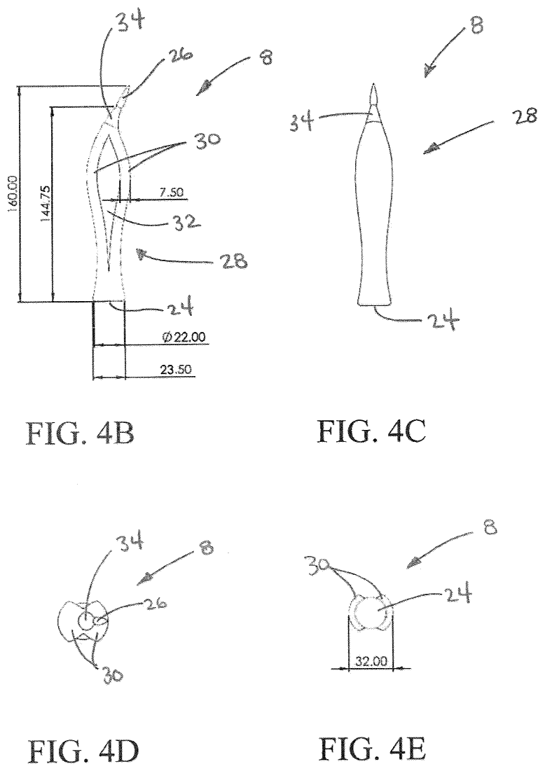

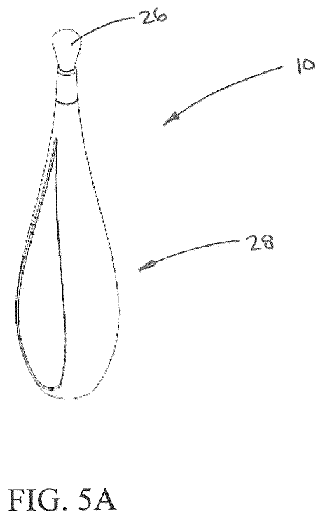

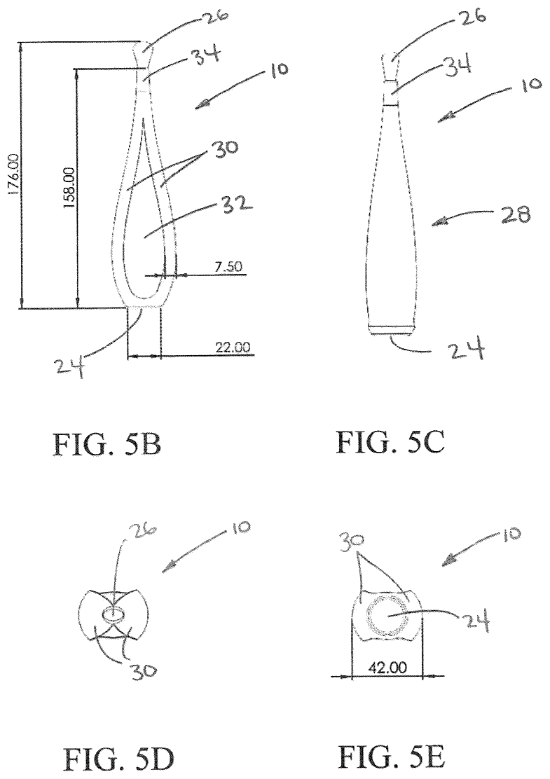

A second tool in the form of an eyeliner brush 8 is shown in FIGS. 4A to 4E and a third tool in the form of an eyeshadow brush 10 is shown in FIGS. 5A-5E. Each of the eyeliner brush 8 and eyeshadow brush 10 include a working feature 26 in the form of a brush at the top of the tool and a magnet 24 at the bottom of the tool. In a preferred embodiment the eyeliner brush 8 and eyeshadow brush 10 will have a collar 34 to connect the brush 26 to the handle 28, with different brush and collar sizes and shapes depending on the application.

For example, an eyeliner brush 8 may have an angled collar 34, which acts as a support to rest against the user's face during application of eyeliner, providing guided, precision strokes. On the other hand, the eyeshadow brush 10 may have a more straight, vertical collar 34. The collar 34 and brush 26 are preferably permanently fastened to the handle 28, but maybe releasably attached to allow replacement of a worn working feature 26.

The preferred eyeliner brush 8 and eyeshadow brush 10 have handle portions 28, preferably comprising a plurality of handle segments 30 with a space 32 between handle segments 30. This configuration allows the user to weave their fingers around the handle segments 30 and through the spaces 32, to help accommodate for some impairments. The spaces 32 can vary in their placement, size and shape, depending on the type of tool or working feature. Generally, the widest portion of the space 32 is where the user should be holding the tool for optimal control.

For example, the eyeliner brush 8 preferably has a wide space closer to the brush 26, as it likely requires that the user rest their hand against their face as they use the brush 26. The eyeshadow brush 10 preferably has a wide space closer to the bottom, since less control is generally needed.

More particularly, a preferred eyeshadow brush 10 or 110 or a blush brush 112 may have a teardrop shaped space 32 between handle segments 30, with the wider space closer to the second end of the handle and farther away from the working feature 26. In a preferred embodiment, the handle segments 30 converge in an acute angle near the working feature 26 and in a wide, obtuse angle at the second, bottom end of the tool.

In one preferred embodiment, the handle segments 30 are optionally able to flex, like a whisk, to accommodate for different grip strengths, and have a soft texture so as not to be slippery, to improve grip. Moreover, the handle segments 30 preferably create at least one flat or relatively flat plane, rather than being entirely cylindrical, so that the tool will not roll off of a flat surface if placed on its side.

It is contemplated that the eyeliner brush 8, the eyeshadow brush 10 and 110, and the blush brush 112 are be made of plastic, preferably a polypropylene or polyethylene, with a metal collar, preferably being aluminum or stainless steel, and an elastomeric covering on at least a portion of the handle segments 30, preferably being a thermoplastic polyurethane (TPU) for improved grip. Of course, any suitable materials may be used depending on the tool and the application.

In the preferred embodiment of FIGS. 7, 8 and 9, the set 2′ comprises a series of one or more types of cosmetics brushes, here eyeshadow brushes 110 and blush brushes 112, on a base 4′, shown as one or more long handle brushes 110 and one or more short handle brushes 112.

As described in relation to the eyeshadow brush 10 above, each of the brushes 110 and 112 have handle portions 28 comprising a plurality of handle segments 30 with a space 32 between handle segments 30. The spaces 32 are preferably teardrop shaped, the widest portion of the space 32 being closer to the terminal end of the brush 110 or 112 that rests on the base 4′ for improved control of the brushes 110 and 112.

With respect to brushes 110 and 112, these are generally shaped and sized in accordance with the eyeshadow brush 10 shown in FIGS. 5A to 5E and discussed above, with the working features 26 in the form of brushes shown in broken lines to designate any brush shape in the drawings. In the embodiment shown in FIGS. 7-9. short handle brushes 112 are preferably anywhere in the range of about 50-85% of the height of the long handle brushes 110, with about 75% of the height of the long handle brushes 110 being most preferred.

General dimensions of the base 4 and tools described in this specification are shown in millimeters on the attached drawings, it being understood that any of the dimensions of these tools can vary widely, i.e., by 100% or more, and certainly by 5%, 10%, 15%, 20% or 25%, or even 50% or more, depending on the applications and the intended users.

While certain exemplary embodiments have been described and shown in the accompanying drawings, it is to be understood that such embodiments are merely illustrative and do not limit the current invention. Accordingly, this invention is not restricted to the specific constructions and arrangements shown and described, since variation, modification, and/or alternatives can occur to those ordinarily skilled in the art. All such variations, modifications and/or alternatives are intended to fall within the scope of the present invention.

The term “comprising” as used in the following claims is an open-ended transitional term that is intended to include additional elements not specifically recited in the claims. It is also noted that any feature or element positively identified in this specification may also be specifically excluded as a feature or element of an embodiment of the present invention.

1. A base and tool set comprising:
a base having at least a first designated area and a second designated area, each of the designated areas comprising one of a magnet and a metal element;
a first tool comprising a first end corresponding to a working feature and a second end opposite the working features, said first tool corresponding to the first designated area having the other of the magnet and metal element associated with the second end of the first tool; and
a second tool comprising a first end corresponding to a working feature and a second end opposite the working features, said second tool corresponding to the second designated area having the other of the magnet and metal element associated with the second end of the second tool;
wherein the first and second tools stand on the base respectively on the first and second designated areas in an upright orientation.

2. The base and tool set of claim 1, where the first tool is a first type of cosmetics brush and the second tool is a different cosmetics brush.

3. The base and tool set of claim 1, wherein the base further comprises one or more visual designations for defining placement of the tools.

4. The base and tool set of claim 1, wherein the first tool is taller than the second tool.

5. The base and tool set of claim 1, wherein the working feature of each of the first and second tools is a cosmetics brush.

6. A handle comprising a first end corresponding to a working feature and a second end opposite the first end, the handle comprising a plurality of converging handle segments with at least one space between handle segments.

7. The handle of claim 6, wherein the plurality of handle segments converge both nearer the first end and nearer the second end.

8. The handle of claim 6, wherein the at least one space is preferably teardrop shaped with the widest portion of the space being closer to the second end of the handle.

9. The handle of claim 6, further comprising one of a magnet or a magnetic element associated with the second end of the handle for magnetic attachment to a cooperating base.
